(19) United States
(12) Patent Application Publication
(10) Pub. No.: US 2018/0074467 A1
(43) Pub. Date: Mar. 15, 2018

(54) SYSTEM AND METHOD FOR REDUCING VIBRATION IN A COMPUTER CONTROLLED RESURFACING MACHINE

(71) Applicants: Andrew C. Rottler, Seattle, WA (US); Ranjit (Robin) Chera, Chandigarh (IN)

(72) Inventors: Andrew C. Rottler, Seattle, WA (US); Ranjit (Robin) Chera, Chandigarh (IN)

(21) Appl. No.: 15/705,053

(22) Filed: Sep. 14, 2017

Related U.S. Application Data
(60) Provisional application No. 62/394,651, filed on Sep. 14, 2016.

(51) Int. Cl. G05B 13/02; G05B 19/416; B23B 39/22; G05B 19/18

(52) U.S. Cl. CPC G05B 13/024; G05B 19/188; B23B 39/22; G05B 19/4163

(57) ABSTRACT

A resurfacing machine that includes a spindle carrying a resurfacing tool and an electric motor operatively connected to the spindle and configured to rotate the spindle about an axis. The machine includes a control system, such as a processor and a computer readable medium carrying spindle control instructions thereon. The control system is configured to control the operation of the motor in order to rotate the spindle through a repeating acceleration and deceleration cycle during a resurfacing operation.

### CROSS-REFERENCE TO RELATED APPLICATION

This application claims the benefit of U.S. Provisional Application No. 62/394651, filed on Sep. 14, 2016, the disclosure of which is incorporated by reference herein in its entirety.

### BACKGROUND

Engine rebuilding has become a popular alternative to purchasing new engines in such fields as automobiles and watercraft. In some high performance industries such as professional racing, teams build and rebuild their engines before every racing event. To the average consumer and the racing professional alike, accurate machining and rebuilding is a necessity for good performance and reliability of an engine. Resurfacing cylinder heads and engine blocks is an essential aspect of engine building/rebuilding today, whether the work is being done by a production engine rebuilder, a high performance specialist or small custom shop.

Common types of machines used for rebuilding parts of an engine include computer numerical controlled (CNC) machines. These machines can be configured to carry out one or more machining or resurfacing operations, including polishing, boring, honing, reaming, drilling, etc., and are commercially available from Rottler Manufacturing and Sunnen, among others.

### SUMMARY

In accordance with an embodiment of the present disclosure, a computer implemented method is provided for resurfacing at least one surface of a workpiece. The method includes moving a cutting tool with respect to a surface to be resurfaced; and while moving the cutting tool with respect to said surface to be resurfaced, rotating the cutting tool in a repeating cycle comprising alternating acceleration and deceleration stages.

In accordance with another embodiment of the present disclosure, an apparatus is provided. The apparatus includes a spindle carrying a resurfacing tool, an electric motor operatively connected to the spindle and configured to rotate the spindle about an axis, and a control system configured to control the operation of the motor in order to rotate the spindle through a repeating acceleration and deceleration cycle during a resurfacing operation.

In accordance with another embodiment of the present disclosure, a computer readable medium carrying instructions thereon that carry out actions including a vibration reduction operation in which a spindle is cycled between acceleration and deceleration as the spindle is rotated during a resurfacing process.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIG. 1 illustrates one example of a computer controlled resurfacing machine, the resurfacing machine configured to carry out one or more examples of variable spindle speed and/or vibration reduction methods in accordance with aspects of the present disclosure;

FIG. 2 is a partial view of the resurfacing machine of FIG. 1;

FIG. 3 is a block diagrammatic view of one example of a control system in accordance with aspects of the present disclosure;

FIG. 4 is a shot shoot of one graphical user interface (GUI) in accordance with aspects of the present disclosure; and

FIG. 5 is a graph depicting spindle speed vs. time according to one embodiment of a variable spindle speed method.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed. Similarly, any steps described herein may be interchangeable with other steps, or combinations of steps, in order to achieve the same or substantially similar result.

The following description sets forth examples of systems and methods for reducing vibration in a computer controlled machining apparatus, such as a seat and guide resurfacing machine. In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

Although some embodiments of the present disclosure will be described hereinafter with reference to resurfacing a seat and/or guide of an engine cylinder head, it will be appreciated that aspects of the present disclosure have wide application, and therefore, may be suitable for use with many types of machining or resurfacing operations, including polishing, honing, boring, reaming, drilling, etc. Accordingly, the following descriptions and illustrations herein should be considered illustrative in nature, and thus, not limiting the scope of the claimed subject matter.

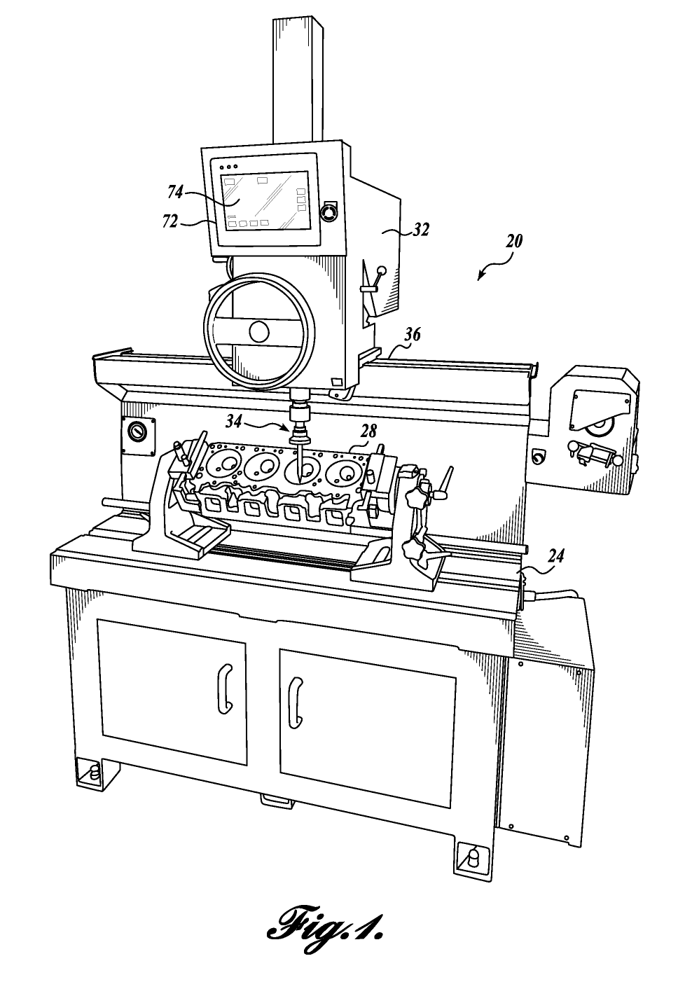

Turning now to FIG. 1, there is shown one example of a computer controlled (e.g., CNC, etc.) machining apparatus, generally designated 20, configured to carry out one or more methods of the present disclosure. The machining apparatus 20, which can either be single purpose or multi-purpose, generally includes a support deck or work table 24 onto which a work piece 28, such as an internal combustion engine cylinder head, is mounted. The work table 24 in some embodiments may be slotted to accommodate conventional fixation devices for stationarily mounting a workpiece 28 to the work table 24 in a suitably fixed position.

In one embodiment, the work table 24 is movable in a substantially horizontal plane (e.g., XY plane) for generally aligning the workpiece with a machine spindle system that will be described in more detail below. In one embodiment, the fixation device can include an adjustable trunnion assembly. The adjustable trunnion assembly may include clamps to hold down the workpiece and an axis aligning control mechanism that permits fine position adjustment of the workpiece. The aligning control mechanism may rotate the workpiece about vertical and horizontal axes. Other movement for permitting fine adjustment may be accomplished by the trunnion assembly, if desired.

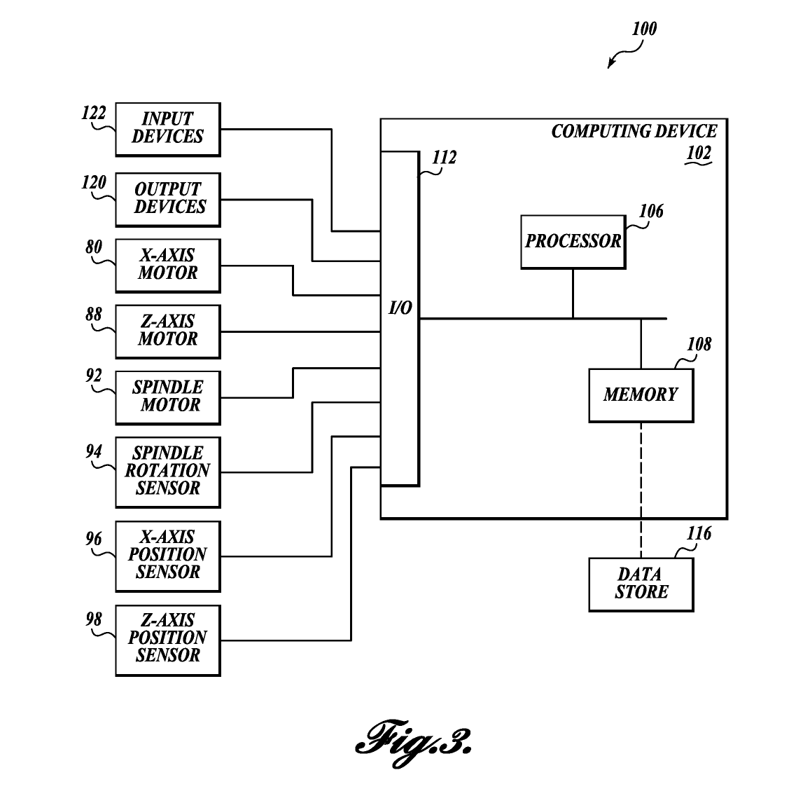

The machining apparatus 20 also includes a tool support 32, which carries a machine spindle system 34. In some embodiments, the tool support 32 is mounted for reciprocating movement via a linear stage 36 oriented in the X-direction (horizontal direction). The linear stage 36 comprises, for example, a linear slide type bearing interface to restrict motion of the tool support 32 in only the X-direction, and a linear drive system for providing reciprocating motion to the tool support 32. In one embodiment, the linear drive system includes, for example, a conventional ball screw mechanism (hidden in FIG. 1) or the like, actuated by, for example, a drive motor 80 (see FIG. 3) under controlled by a control system 100. In some embodiments, the drive motor 80 can include but is not limited to AC or DC electric motors, stepper motors, servo motors, etc. Other means for moving the tool support in the X-direction (and optionally, the Y-direction as described below) can be used. For example, in other embodiments, an air float can be employed. It will be appreciated that the air float can be configured to restrict movement solely in the X-direction or can provide movement in the XY plane (e.g., movement in both the X- and Y-direction). One type of air float that can be practiced with embodiments of the present disclosure can be found on select SG™ series machining stations available from Rottler Manufacturing, Kent, Wash. In other embodiments, the work table 24 is configured to move in the Y-direction while the tool support 32 is configured to move in the X-direction or vice versa. In yet other embodiments, the worktable 24 can be mounted on an XY table for movement of the workpiece with respect to the spindle system in the XY plane.

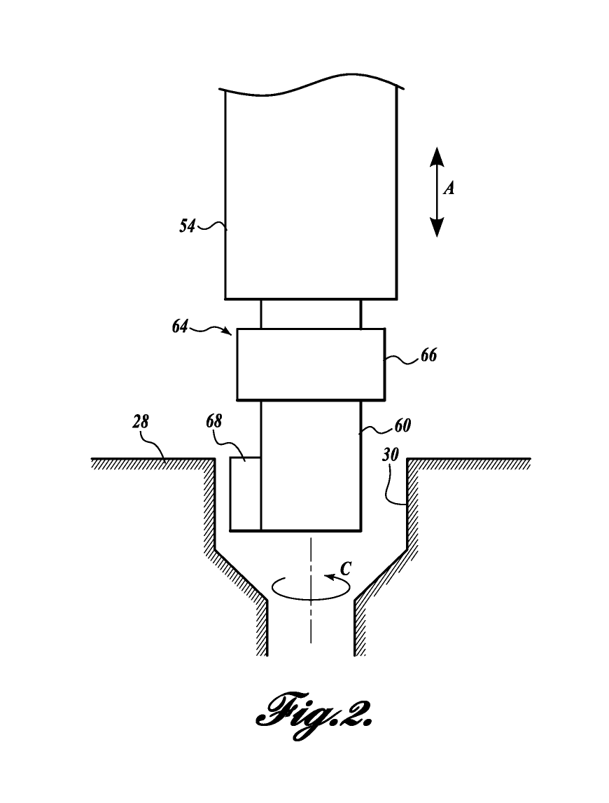

Referring to FIGS. 1 and 2, a spindle system 34 is carried by the tool support 32. The system 34 include a spindle carriage 54 that is carried or otherwise supported by the tool support 32, and is movable in a reciprocating stroking action, denoted by arrow A (see FIG. 2). The reciprocating motion can be implemented by a linear motion system, such as ball screw mechanism driven by a drive motor 88 (see FIG. 3) under control by a control system 100. The spindle carriage 54 is directly or indirectly mounted to the ball nut of the ball screw mechanism. As such, the spindle carriage 54 moves in a reciprocating or stroking manner as the ball screw is rotated via the drive motor 88. As the ball screw rotates, the number of rotations by and the rotational position of the ball screw are precisely detectable by an encoder or other sensor 98 (see FIG. 3) communicatively connected to the drive motor 88 and/or control system 100. Sensors may also be used to sense the position of the ball nut, as known in the art.

As shown in FIGS. 1 and 2, the spindle carriage 54 is supported for reciprocal stroking action in a vertical direction (i.e., Z-axis), but it should be understood that stroking in other directions is also contemplated with embodiments of the present disclosure. As will be described in more detail below, movement of the spindle carriage inserts and withdraws an associated machining tool, such as a resurfacing tool 60, carried by a spindle 64 into and out of, for example, a seat and/or guide of a cylinder head. As will be further described in more detail below, the tool 60 is rotated via spindle 64 about an axis denoted by arrow C, for effecting the desired resurfacing of surface 30 of workpiece 28.

Still referring to FIG. 2, the spindle 64 is operatively coupled to the spindle carriage 54 and is rotatably driven by a spindle drive motor 92 (see FIG. 3) and sensed by, for example, a spindle rotational sensor 94. The spindle 64 includes a tool attachment interface 66 for selectively attaching the machine tool 60 for co-rotation. As shown in the embodiment of FIG. 2, the tool 60 is in the form of a cutting tool and is selectively coupled to the spindle 64. However, the tool 60 can be any conventional or further developed machining tool, and can be selected based on the type of machine operation (e.g., boring, reaming, honing, drilling, milling, etc.) to be carried out by the machining apparatus.

In one embodiment, the machine tool 60 includes an upper, driver section and a lower, tool holder section. In one embodiment, the driver section includes a spindle shaft section. The spindle shaft section in some embodiments is formed with a quick change male taper that may be removably coupled in a rotationally driven manner through a cooperatively configured, one handed automatic tightening spindle lock nut system (hereinafter “lock nut system”) associated with the interface 66. Lock nut systems that may be practiced with embodiments of the present disclosure are described in U.S. Pat. Nos. 7,726,919 and 3,829,109, both of which are hereby expressly incorporated by reference. It will be further appreciated that the machine tool/spindle can incorporate a spherical joint and pilot arrangement of the type known in the industry as the UNIPILOT™, sold with select SG™ series machining stations or sold separately therefrom and available from Rottler Manufacturing, Kent, Wash.

In operation, once inserted into a suitable portion of a work piece 28, such as a seat of a cylinder head, the tool 60 can be rotated, as denoted by arrow C, via the spindle 64 under control of the control system 100 for resurfacing, e.g., cutting, a surface 30 of a work piece 28. In a typical application, as spindle carriage 54 is reciprocally stroked upwardly and downwardly, as denoted by arrow A, the tool 60 will rotate in one direction or the other, as denoted by arrow C, within a hole, seat, etc., of a workpiece, for providing a desired size, surface finish and/or shape to one or more surfaces of such a hole, seat, guide, etc.

Other linear drive systems can be practiced with embodiments of the present disclosure, including drive motor actuated cam linkage mechanisms, roller screws, rack and pinion, hydraulic or pneumatic cylinders, chain or belt drives, etc. For example, any of the ball screw mechanisms described herein could be substituted with other means of rotary to linear motion conversion (e.g., rack & pinion, etc.,) or that the motor, encoder/sensor and ball screw together could be substituted with a linear motor and linear encoder, or any other system of providing precise position controlled linear motion.

In some embodiments, examples of machining apparatus that may be practiced with or carry out methods of embodiments of the present disclosure include, but are not limited to, the SG™ series of machining stations available from Rottler Manufacturing, Kent, Wash.

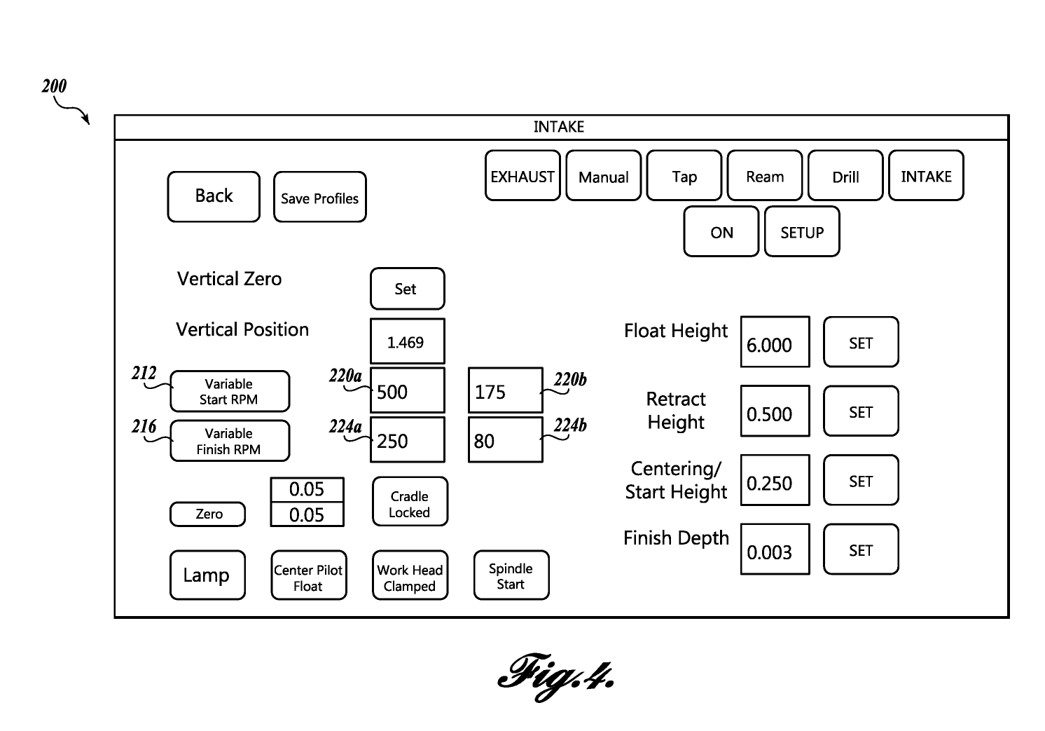

As briefly described above, the drive motors 80 and 88, and spindle motor 92 are operated under the control of a control system 100. FIG. 3 illustrates one example of the control system 100 in block diagrammatic form. As will be described in more detail below, the control system 100 includes one or more computing devices 102 suitably programmed to interface with a system operator via a control station 72 (see FIG. 1), and to carry out either automated or manually inputted instructions. As will be described in more detail below, the control station 72 includes one or more human machine interface devices, including display 74. At the control station 72, the system operator interfaces with the control system 100 via human machine interface devices such as one or more displays, keyboards, joysticks, trackballs, touchpads, control dials, and/or the like. In some embodiments, the one or more computing devices render a graphical user interface (GUI) on the display 74 in order to graphically interface with the system operator. One example of a GUI rendered on the display 74 is illustrated in FIG. 4. From the input of various data relating to the workpiece and to the type of machine operation to be performed, the one or more computing devices 102 implements CNC and/or CAM machining instructions in order to machine the mounted workpiece 28 with the tool 60.

One example of the one or more computing devices 102 will now be described in more detail. In some embodiments, the one or more computing devices 102 either separately or in combination may include at least one processor 106 or central processing unit (CPU), a memory 108, and I/O circuitry 112 suitably interconnected via one or more buses. Depending on the exact configuration and type of device, the memory 108 may include system memory in the form of volatile or nonvolatile memory, such as read only memory (“ROM”), random access memory (“RAM”), EEPROM, flash memory, or similar memory technology. The system memory is capable of storing one or more programs, that are immediately accessible to and/or currently being operated on by the CPU. In this regard, the CPU serves as a computational center of the computer 100 by supporting the execution of instructions.

The memory 108 may also include storage memory, and may include a data store 116. The storage memory may be any volatile or nonvolatile, removable or nonremovable memory, implemented using any technology capable of storing information. Examples of storage memory include but are not limited to a hard drive, solid state drive, CD ROM, DVD, or other disk storage, magnetic cassettes, magnetic tape, magnetic disk storage, and the like. The information stored in the storage memory to be accessed by the CPU includes but is not limited to program modules, such as an operating system (Microsoft Corporation's WINDOWS®, LINUX, Apple's Leopard, etc.), and one or more CNC and/or CAM modules for carrying out one or more machining operations of the apparatus. Generally, program modules or “engines” may include routines, applications, objects, components, data structures, etc., that perform particular tasks or implement particular abstract data types. In some embodiments, the one or more CNC machining modules are configured to operate the apparatus based, in part, on obtained data (e.g., inputted from user, access from operational history, etc.) in order to carry out one or more machining operations (e.g., boring, honing, reaming, milling, porting, etc.). The memory 108 also stores one or more variable spindle speed and/or vibration reduction modules, routines, etc.

As used herein, the term processor is not limited to integrated circuits referred to in the art as a computer, but broadly refers to a microcontroller, a microcomputer, a microprocessor, a programmable logic controller, an application specific integrated circuit, other programmable circuits, combinations of the above, among others. In one embodiment, the processor 104 executes instructions stored in memory 108, such as CNC machining instructions, CAM instructions, etc.

The modules or “engines” stored in memory 108 as well as other modules associated with the control system 100 may include one or more sets of control algorithms, determination algorithms, numerical control instructions, etc., including resident program instructions and calibrations stored in one of the storage mediums and executed to provide desired functions. Information transfer to and from the modules can be accomplished by way of a direct connection, a local area network bus and a serial peripheral interface bus.

The algorithms may be executed during preset loop cycles such that each algorithm is executed at least once each loop cycle. Algorithms stored in the non-volatile memory devices are executed by the processor to monitor inputs from the sensing devices, such as sensors 94, 96, 98, etc., and other data transmitting devices or polls such devices for data to be used therein. Loop cycles are executed at regular intervals, for example each 3.125, 6.25, 12.5, 25 and 100 milliseconds during ongoing operation of the apparatus. Alternatively, algorithms may be executed in response to the occurrence of an event.

Still referring to FIG. 3, the processor 106 communicates with various data sources 94, 96, 98, 120, 122 (sensors, HMI devices), with motors 80, 88, 92, etc., directly or indirectly via an input/output (I/O) interface 112 and suitable communication links. The interface 112 may be implemented as a single integrated interface that provides various raw data or signal conditioning, processing, and/or conversion, short-circuit protection, and/or the like. Alternatively, one or more dedicated hardware or firmware chips may be used to condition and process particular signals before being supplied to/from the processor 106. In some embodiments, the signals transmitted from the interface 112 may be suitable digital or analog signals to control components of the system 100. Other components may be employed, such as control circuits, PLCs, etc., as known in the art, for controlling the drive motors (e.g., AC or DC electric motors, stepper motors, servo motors). For example, one or more devices may be utilized to convert control signals from the I/O into appropriate device specific control signals to be carried out by the motors, etc. In some embodiments, the I/O may include these and/or other control devices. In one embodiment, the I/O includes one or more PLCs for controlling one or more of the spindle drive motor 92, motor 80, and/or motor 92.

The one or more computing devices 102 may also interface with one or more output devices 120 in the form of graphical display 74 (e.g., liquid crystal display (LCD), light emitting polymer display (LPD), plasma display, Light emitting Diode (LED) display, Organic Light emitting Diode (OLED) display, etc.). The one or more computing devices 102 may also include one or more input devices 122, such as a keyboard, touch pad, joystick, cameras, a pointing device, among others. In one embodiment, the display 74 can also be configured as a touchscreen for inputting data. The output devices 120 and input devices 122 can also be referred to as HMI devices herein. The output devices and the input devices are suitably connected through appropriate interfaces of the I/O circuitry. As would be generally understood, other input/output devices may also be connected to the processor in a similar manner.

FIG. 4 is a screen shot of one graphical user interface 200 presented by display 74 during, for example, set-up of the control system. The GUI 200 is capable of implementing, in conjunction with logic in memory, a variable speed spindle cutting process. Briefly described, one embodiment of a variable spindle speed program module, also referred to as a vibration reduction program module, implemented or otherwise carried out by the control system 100 varies the RPM of the spindle, for example at a constant rate, so that the resurfacing tool is always accelerating or decelerating while it is cutting the surface of the workpiece. Operation of the spindle via implementation of the various embodiments of the variable spindle speed program module described herein aims to prevent a buildup of frequency harmonics and help prevent chatter (e.g., vibration reduction) of the cutter on the cutting surface.

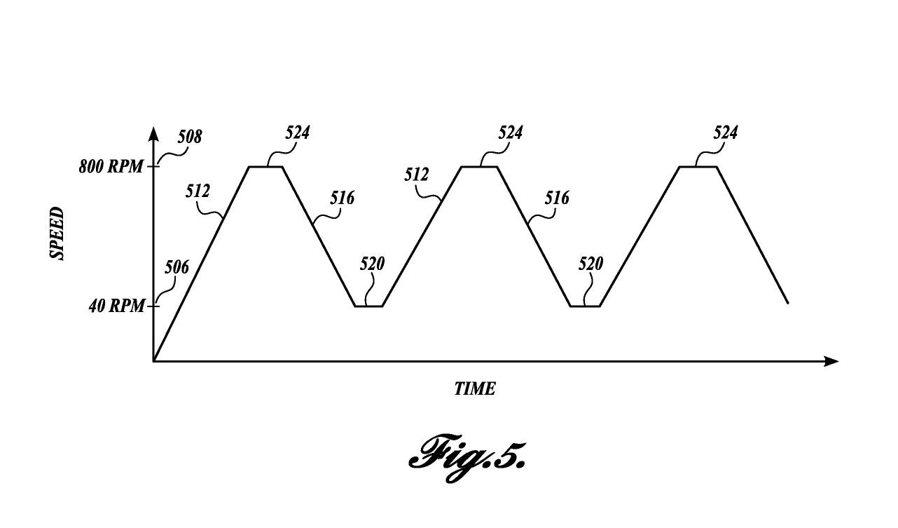

In one embodiment, as depicted in the graph of FIG. 5, the speed of the spindle starts from rest (at the left hand side of the graph) and cycles between a LOW RPM value 506 and a HIGH RPM value 508. In the embodiment of FIG. 5, the speed of the spindle cycles between a LOW RPM value of 40 and a HIGH RPM value of 800. As it cycles, the spindle accelerates during an acceleration stage 512 and decelerates during a deceleration stage 516 between the LOW RPM value and the HIGH RPM value. The difference between the LOW RPM value and the HIGH RPM value in some embodiments is a factor of greater than 3, a factor of between 10 and 30, a factor of between 15 and 25 in other embodiments, and a factor of about 20 in yet other embodiments. For example, in some embodiments, if the LOW RPM value is 40, then the HIGH RPM value would be greater than 120, and if the LOW RPM value is 40 in other embodiments, then the HIGH RPM value would range between 400 and 1200, and if the LOW RPM value is 40 in other embodiments, then the HIGH RPM value would range between 600 and 900, and if the LOW RPM value is 40 in the other embodiments, then the HIGH RPM value would be 800, respectively.

In some embodiments, the acceleration and declaration times are identical. In one embodiment, the acceleration time and the deceleration time is 40 milliseconds. In other embodiments, the acceleration and declaration times are different. In some embodiments, the spindle is accelerated with a constant acceleration. In other embodiments, the spindle is accelerated with a non-constant or varying acceleration. In some embodiments, the spindle is decelerated with a constant deceleration. In other embodiments, the spindle is decelerated with a non-constant or varying deceleration. In some embodiments, dwell times, designated at 520 and 524 at the LOW RPM and HIGH RPM, respectively, are 5 milliseconds.

In accordance with an aspect of the present disclosure, the spindle speed (constant) or speeds (variable) can change during the cutting operation of the cutting tool under control of the control system. For example, a cutting operation of, for example, a valve seat, may involve two stages, a rough or start cut stage in which the spindle moves in a first direction along the Z-axis to a predetermined position (e.g., finish depth) and a finish cut stage in which the spindle moves in a direction opposite the first direction along the Z-axis to return to its start position. In some embodiments, the spindle speed during the rough cut stage is faster than the spindle speed during a finish cut stage or vice versa.

In some cutting operations, the cutting tool can make multiple passes into, out of, or through the object to be resurfaced. The spindle speed of each subsequent pass in some of these embodiments may be faster than the previous pass. In other of these embodiments, the spindle speed of each subsequent pass may be slower than the previous pass. The spindle during each pass, stage, etc., may be operated with a variable speed as described above, while in other embodiments, the spindle may be operated during one or more stages or passes of a set of stages or passes with a variable speed while the spindle is operated during the remaining stages or passes of the set of stages or passes with a constant speed. In some embodiments, at least the finish cut stage or final pass of the spindle is operated via implementation of the one of the various embodiments of the with variable spindle speed program module discussed above.

Returning to FIG. 4, the HIGH RPM and LOW RPM values for both start of cut and finish of cut can be programmable by the operator via the GUI 200. Both the start cut and finish cut can be active for variable speed cutting or shut off for steady speed cutting. In some embodiments, the variable RPM buttons 212, 216 displayed by the GUI will toggle between constant RPM settings and variable RPM settings. For example, in constant speed mode, a single value box indicates constant RPM setting, and in variable speed mode, dual value boxes 220a, 220b, and 224a, 224b indicate variable RPM settings. Via the GUI, the operator can activate the variable speed buttons and input values for the HIGH and/or LOW RPM in their respective boxes during setup and then can run the machine under normal operation by, for example, pressing a start button. RPM settings are automatically activated when the spindle turns on and continue until the spindle shuts off. In one embodiment, regardless of activation of the start and/or finish variable speed mode, the spindle is constantly accelerating and decelerating according to, for example, vibration reduction techniques or methodologies, as described above.

The present disclosure may include references to directions, such as “upper,” “lower,” “upward,” “downward,” “top,” “bottom,” “first,” “second,” etc. These references and other similar references in the present disclosure are only to assist in helping describe and understand the exemplary embodiments and are not intended to limit the claimed subject matter to these directions.

The present disclosure may also reference quantities and numbers. Unless specifically stated, such quantities and numbers are not to be considered restrictive, but exemplary of the possible quantities or numbers associated with the present disclosure. Also in this regard, the present disclosure may use the term “plurality” to reference a quantity or number. In this regard, the term “plurality” is meant to be any number that is more than one, for example, two, three, four, five, etc. The terms “substantially,” “about,” “approximately,” etc., mean plus or minus 5% of the stated value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure.

1. A computer implemented method for resurfacing at least one surface of a workpiece, comprising:
moving a cutting tool with respect to a surface to be resurfaced; and
while moving the cutting tool with respect to said surface to be resurfaced, rotating the cutting tool in a repeating cycle comprising alternating acceleration and deceleration stages.

2. The computer implemented method of claim 1, wherein the duration of the acceleration stage and deceleration stage are the same.

3. The computer implemented method of claim 1, wherein the duration of the acceleration stage and deceleration stage are different.

4. The computer implemented method of claim 1, wherein acceleration of the spindle during the acceleration stage is constant.

5. The computer implemented method of claim 1, wherein acceleration of the spindle during the acceleration stage is non-constant.

6. The computer implemented method of claim 1, wherein deceleration of the spindle during the deceleration stage is constant.

7. The computer implemented method of claim 1, wherein deceleration of the spindle during the deceleration stage is non-constant.

8. The computer implemented method of claim 1, wherein said rotating the spindle further includes rotating the spindle between a selected low RPM value and a selected high RPM value.

9. The computer implemented method of claim 8, wherein the selected high RPM value is greater than the selected low RPM value by a factor of 3 or greater.

10. The computer implemented method of claim 9, wherein the selected high RPM value is greater than the selected low RPM value by a factor selected from the group consisting of between 10 and 30, between 15 and 25, and about 20.

11. An apparatus, comprising:
a spindle carrying a resurfacing tool;
an electric motor operatively connected to the spindle and configured to rotate the spindle about an axis; and
a control system configured to control the operation of the electric motor in order to rotate the spindle through a repeating acceleration and deceleration cycle during a resurfacing operation.

12. The apparatus of claim 11, wherein the repeating acceleration and deceleration cycle comprises an acceleration stage and deceleration stage arranged in a alternating manner.

13. The apparatus of claim 11, wherein the duration of the acceleration stage and deceleration stage are the same.

14. The apparatus of claim 11, wherein the duration of the acceleration stage and deceleration stage are different.

15. The apparatus of claim 11, wherein acceleration of the spindle during the acceleration stage and the deceleration of the spindle during the deceleration stage is selection from a group consisting of:
(a) the acceleration of the spindle during the acceleration stage is constant and the deceleration of the spindle during the deceleration stage is constant;
(b) the acceleration of the spindle during the acceleration stage is non-constant and the deceleration of the spindle during the deceleration stage is constant;
(c) the acceleration of the spindle during the acceleration stage is constant and the deceleration of the spindle during the deceleration stage is non-constant; and
(d) the acceleration of the spindle during the acceleration stage is non-constant and the deceleration of the spindle during the deceleration stage is non-constant;

16. The apparatus of claim 11, wherein the control system is configured to rotate the spindle between a selected low RPM value and a selected high RPM value.

17. The apparatus of claim 11, wherein the selected high RPM value is greater than the selected low RPM value by a factor of 3 or greater.

18. A computer readable medium carrying instructions thereon that carry out actions including a vibration reduction operation in which a spindle is cycled between acceleration and deceleration as the spindle is rotated during a resurfacing process.
